(19) United States
(12) Patent Application Publication
(10) Pub. No.: US 2010/0106363 A1
(43) Pub. Date: Apr. 29, 2010

(54) Climate Control System For A Vehicle

(76) Inventor: Danny Mandujano, Racine, WI (US)

Correspondence Address: HARSHAW RESEARCH, INC., 210 W. TECUMSEH STREET, OTTAWA, KS, 66067, US

(21) Appl. No.: 12/259,397

(22) Filed: Oct. 28, 2008

(51) Int. Cl. G06F 17/00

(52) U.S. Cl. 701/36

(57) ABSTRACT

A climate control system for a vehicle includes an input device, display, and first thermometer inside the vehicle. The system includes a first sensor configured to determine if the vehicle has been put into gear. A first processor is in data communication with the input device, display, first thermometer, first sensor, and vehicle controls. A clock, first receiver, and first transmitter are in data communication with the first processor. The system includes a remote control unit having a second input device, interface output device, second receiver for communicating with the first transmitter, second transmitter for communicating with the first receiver, and second processor, the second processor being in data communication with the second input device, the interface output device, the second receiver, and the second transmitter. The processors include programming for actuating the transmitters and receivers and actuating vehicle system controls according to user supplied specifications.

### BACKGROUND OF THE INVENTION

This application relates generally to an automobile preset starter system and, more particularly, to a control system for a vehicle that enables a driver to predetermine climate conditions within a vehicle prior to a chosen departure time.

Preparing to drive a vehicle may be a frustrating, time consuming, and difficult task when the vehicle has been parked in a location subject to harsh weather conditions, such as snow, freezing rain, or bitterly cold temperatures. In these conditions, a driver may be required to scrape ice off the windshield, operate the defroster and heater once the engine warms sufficiently, and set the radio controls. Depending on the severity of the weather conditions, including an amount of precipitation and the current temperature, the period of time to warm the vehicle or to defrost the windshield will be variable.

Various devices have been proposed in the art for pre-starting a vehicle engine, such as systems for either starting the engine at a predetermined time or merely upon receiving a signal from a remote signaling device actuated by a user. Although assumably effective for their intended purposes, the existing devices do not enable a driver to set a predetermined departure time as well as multiple environmental conditions within the vehicle, including internal temperature, heating/cooling of the seats, defrosting of the windshield, setting of the radio, and the like.

Therefore, it would be desirable to have a climate control system for a vehicle that enables a user to set a predetermined departure time by which time multiple user-determined environmental conditions regarding the vehicle must be attained. Further, it would be desirable to have a climate control system for a vehicle in which climate controls may be set using a main unit or using a remote unit.

### SUMMARY OF THE INVENTION

A climate control system according to the present invention for use with a vehicle having an engine, a starter to actuate the engine, a kill switch to deactivate the engine, a windshield, a heater, an air conditioner, and a defroster includes an input device, a display, and a first thermometer inside the vehicle. The system includes a first sensor configured to determine if the vehicle has been put into gear. A first processor is in data communication with the input device, the display, the first thermometer, the first sensor, the starter, the heater, the air conditioner, and the defroster. A clock, a first receiver, and a first transmitter are in data communication with the first processor. The system includes a remote control unit having a second input device, an interface output device, a second receiver for communicating with the first transmitter, a second transmitter for communicating with the first receiver, and a second processor, the second processor being in data communication with the second input device, the interface output device, the second receiver, and the second transmitter.

The first processor includes programming to actuate the second transmitter to relay data input through the second input device to the first receiver. The second processor includes programming to actuate the interface output device to present data received by the second receiver from the first transmitter. The first processor includes programming to actuate the starter to activate the engine at a time interval before a specified departure time, the specified departure time being input through one of the input device inside the vehicle and the second input device. The first processor further includes programming to actuate the heater if internal temperature data from the first thermometer indicates that internal temperature is below a specified internal temperature after the starter is actuated, the specified internal temperature being input through one of the input device inside the vehicle and the second input device. Further, the first processor may include programming to actuate the air conditioner if internal temperature data from the first thermometer indicates that internal temperature is above the specified internal temperature after the starter is actuated. The first processor may also include programming to actuate the kill switch if the first sensor does not determine that the vehicle has been put into gear within a specified time after the specified departure time.

Therefore, a general object of this invention is to provide a climate control system for a vehicle that a user may set to a predetermined departure time, temperature, and other internal climate conditions.

Another object of this invention is to provide a climate control system, as aforesaid, that senses external climate conditions and, as a result, may actuate other engine controls accordingly, such as the defroster or windshield wipers.

Still another object of this invention is to provide a climate control system, as aforesaid, having a remote unit by which a user may input instructions to be carried out by a vehicle unit at a predetermined/user set time.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a climate control system according to a preferred embodiment of the present invention;

FIG. 1b is an isolated view on an enlarged scale of a vehicle unit taken from a portion of FIG. 1a;

FIG. 2 is a perspective view of a remote unit according to the climate control system;

FIG. 3 is a block diagram illustrating the climate control system in use with a vehicle;

FIG. 4 is a flowchart illustrating the steps performed by processors according to the present invention; and

FIG. 5 is another flowchart illustrating the steps performed by the processors.

### DESCRIPTION OF THE PREFERRED EMBODIMENT

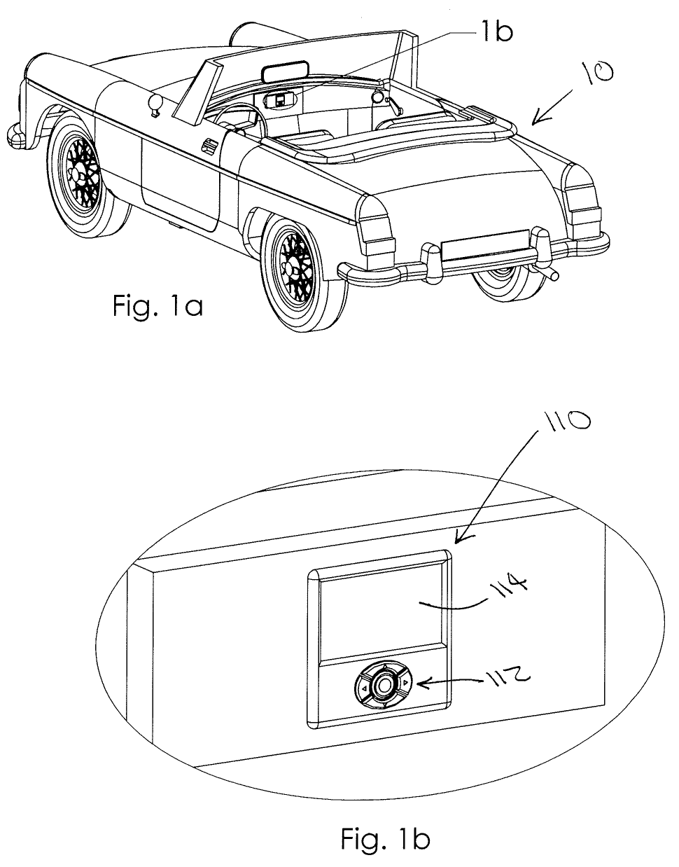

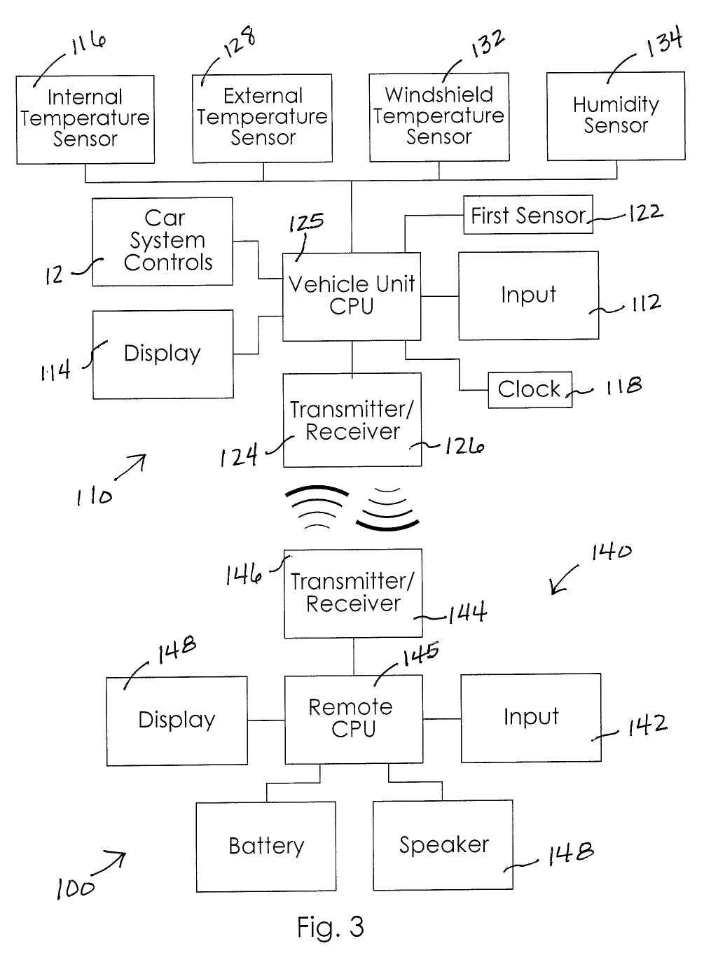

A climate control system for a vehicle will now be described in detail with reference to FIG. 1a through FIG. 5 of the accompanying drawings. More particularly, a climate control system 100 for a vehicle 10 includes a vehicle unit 110 and a remote control (or “remote”) unit 140. The vehicle 10 may include various elements (collectively denoted by reference number 12 in FIG. 3) known to be present in vehicles, whether currently or in the future. For example, the vehicle 10 may include an engine, a starter to actuate the engine, an engine-off mechanism (e.g., a kill switch) to deactivate the engine, a heater, an air conditioner, a defroster, a seat temperature control device, a radio, and/or a windshield 14 (FIG. 1a).

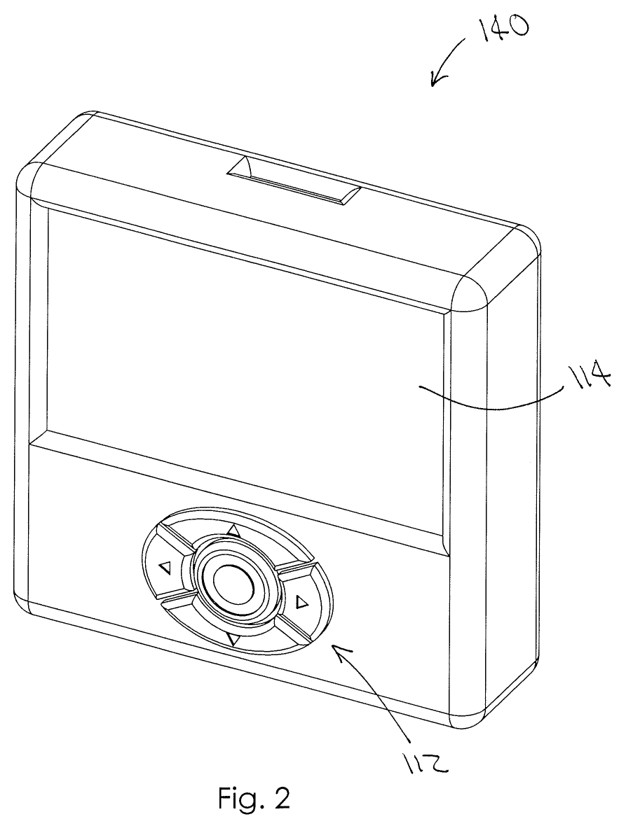

As shown in FIG. 1a through FIG. 2, the vehicle unit 110 is coupled to the vehicle 10 and the remote unit 140 is separate from the vehicle 10. The vehicle unit 110 includes a first input device 112 (e.g., a keypad, touch screen, etc.), a first interface output device 114 (e.g., a display, speaker, etc.), a first thermometer 116 inside the vehicle 10, a clock 118, a first sensor 122 to determine if the vehicle 10 has been put into gear, a first receiver 124, and a first processor 125, as shown in FIG. 3. The first processor 125 is in data communication with the first input device 112, the first interface output device 114, the first thermometer 116, the clock 118, the first sensor 122, the first receiver 124, and the various vehicle elements 12 (e.g., the starter, the engine-off mechanism, the heater, the air conditioner, the defroster, the seat temperature control device, the radio, etc.). The vehicle unit 110 may further include a first transmitter 126, a second thermometer 128 outside the vehicle, a windshield temperature sensor 132, and/or a humidity sensor 134 in data communication with the first processor 125.

The remote unit 140 (FIGS. 2 and 3) includes a second input device 142 (e.g., a keypad, touch screen, etc.), a second transmitter 146 for communicating with the vehicle unit receiver 124, and a second processor 145. The second processor 145 is in data communication with the second input device 142 and the second transmitter 146. The remote unit 140 may further include a second receiver 144 for communicating with the first transmitter 126 and a second interface output device 148 (e.g., a display, speaker, etc.) in data communication with the second processor 145. Programming in the second processor 145 may cause the second processor 145 to actuate the second transmitter 146 to relay data input through the second input device 142 to the first receiver 124, and to actuate the second interface output device 148 to present data received by the second receiver 144 from the first transmitter 126.

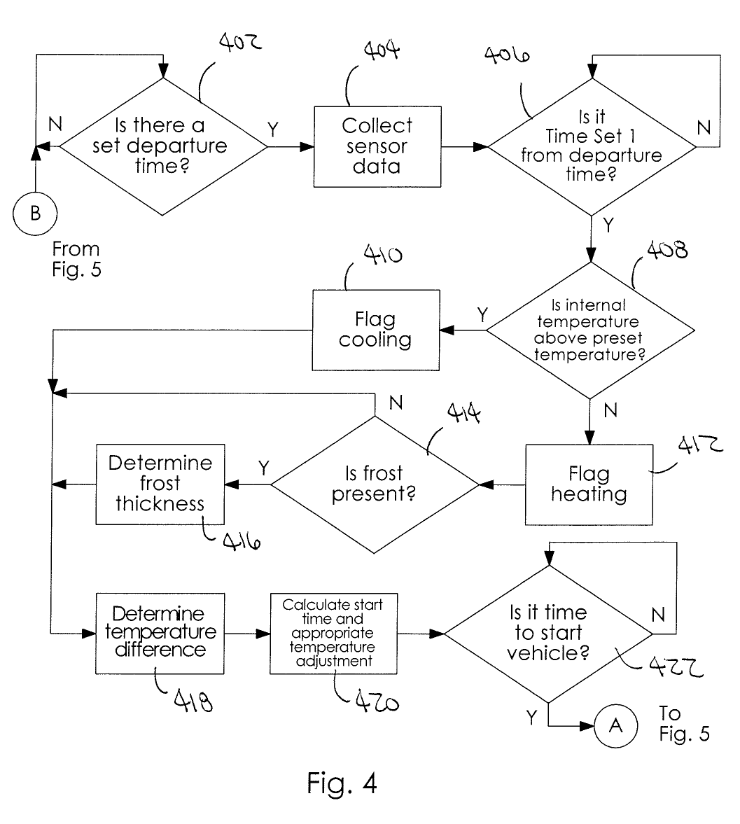

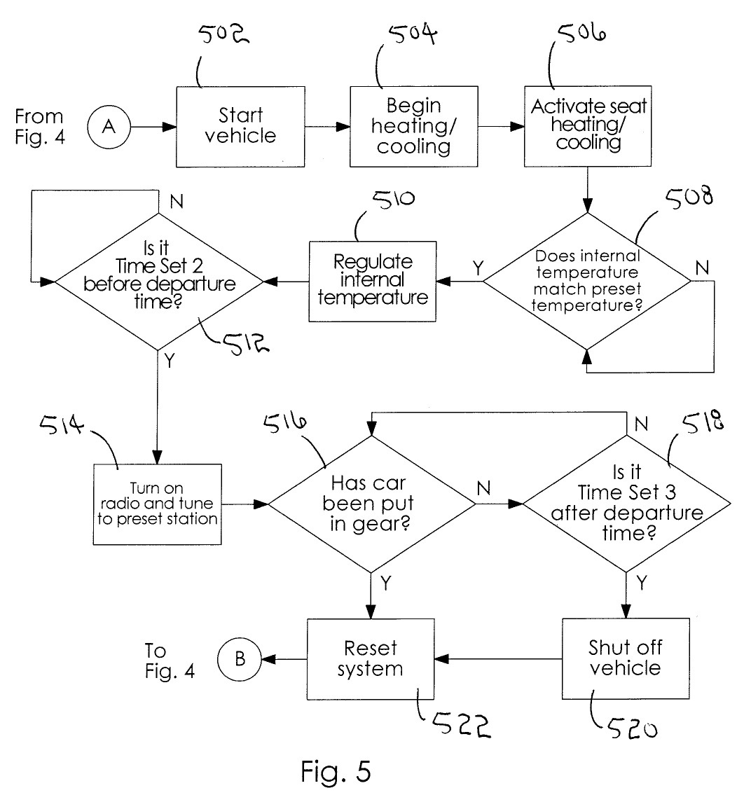

FIG. 4 and FIG. 5 illustrate steps that may be undertaken in relation to the vehicle unit 110 and the remote unit 140, and, more specifically, illustrate various programming in the first processor 125 and/or the second processor 145. It should be understood that various steps in FIG. 4 and FIG. 5 may be rearranged (i.e., placed in different order) or omitted, and that other steps may be added. At step 402, the first processor 125 determines if a specified departure time and a specified internal temperature have been input (e.g., through the first input device 112 or the second input device 142). If so, the first processor 125 proceeds to start the vehicle (i.e., by actuating the starter) at a time interval before the specified departure time (steps 422 and 502).

The time interval before the specified departure time may be input through the first input device 112 or the second input device 142 (e.g., a time interval may be input; a weather condition may be input, and a time interval may correspond to the weather condition; etc.), may be a standard preselected time interval (e.g., a default or permanent time interval), or may be determined by the system 100. For example, to be determined by the system 100, the first processor 125 may collect various sensor data (e.g., from the internal thermometer 116, the external thermometer 128, the windshield temperature sensor 132, and the humidity sensor 134) at step 404. As shown in chart element 406, the sensor data may be collected continuously or periodically, and the first processor 125 may advance to the next step after a set time before the specified departure time (e.g., 15 minutes, 20 minutes, 30 minutes, etc.); alternately, the sensor data may be obtained at the set time before the specified departure time, or chart element 406 may be entirely omitted. Regardless, the first processor 125 may use the sensor data at steps 408, 410, 412, 414, 416, 418, and 420.

At step 408, the first processor 125 determines if the internal temperature is above the specified internal temperature. If so, the first processor 125 determines that air conditioning will be required at step 410, and the first processor 125 continues to step 418; if not, the first processor 125 determines that heating will be required at step 412. After step 412, the first processor 125 determines from the sensor data (or from weather condition input by the user) if ice or snow is likely to be on the windshield 14 at step 414. If not, the first processor 125 continues to step 418; if so, the first processor 125 determines that defrosting will be required and estimates the amount of snow/ice at step 416 from the sensor data. The first processor 125 continues from step 416 to step 418.

At step 418 and 420, the first processor 125 determines the difference in the internal temperature and the specified internal temperature and calculates the time interval before the specified departure time based on the sensor data and the amount of time that will be required to achieve the specified internal temperature and defrost any snow/ice. By calculating the time interval before the specified departure time, the vehicle may be started when necessary instead of too early (which would waste fuel) or too late (which could prevent the specified internal temperature from being reached by the specified departure time). Using user input may provide similar benefits, though likely not to the same extent, over using a standard preselected time interval.

Once the first processor 125 actuates the starter to start the engine at the time interval before the specified departure time at step 502, the first processor 125 at steps 504, 506, 508, and 510 actuates the heater, the air conditioner, the defroster, and the seat temperature control device in accordance with the determinations made at steps 408, 410, 412, and 414 and additional data from the various sensors. As shown by step 510, the first processor 125 regulates the heater, air conditioner, etc. to stay at the specified internal temperature once the specified internal temperature is reached.

The first processor 125 may further actuate the radio to a preselected station (i.e., a station selected through the first input device 112 or the second input device 142) at or before the specified departure time once the starter is actuated, as shown at step 514. As shown at step 512, the first processor 125 may wait to actuate the radio until shortly before the specified departure time to conserve energy.

At steps 516 and 518, the first processor 125 determines (e.g., using data from the first sensor 122) whether the vehicle 10 has been put into gear by a specified time after the specified departure time. The specified time after the specified departure time may be input through the first input device 112 or the second input device 142, or may be a standard preselected time interval. If the specified time after the specified departure time passes before the vehicle 10 has been put into gear, the first processor 125 actuates the engine-off mechanism, as shown at step 520. Otherwise (or after the vehicle is shut off at step 520), the system is reset (step 522) and the first processor 125 returns to step 402.

Though not shown in FIG. 4 and FIG. 5, the first processor 125 may include programming to actuate the first transmitter 126 to send reminder data to the second receiver 144 for presentation by the second interface output device 148 to remind a user of the specified departure time, and/or the second processor 145 may include programming to actuate the second interface output device 148 to remind a user of the specified departure time (without receiving data from the first transmitter 126).

It is understood that while certain forms of this invention have been illustrated and described, it is not limited thereto except insofar as such limitations are included in the following claims and allowable functional equivalents thereof.

1. A climate control system for a vehicle having an engine, a starter to actuate said engine, a kill switch to deactivate said engine, a windshield, a heater, an air conditioner, and a defroster; said system comprising:
an input device inside said vehicle;
a display inside said vehicle;
a first thermometer inside said vehicle;
a first sensor to determine if said vehicle has been put into gear;
a first processor in data communication with said input device inside said vehicle, said display inside said vehicle, said first thermometer, said first sensor, said starter, said heater, said air conditioner, and said defroster;
a clock in data communication with said first processor;
a first receiver in data communication with said first processor;
a first transmitter in data communication with said first processor;
a remote control unit having a second input device, an interface output device, a second receiver for communicating with said first transmitter, a second transmitter for communicating with said first receiver, and a second processor; said second processor being in data communication with said second input device, said interface output device, said second receiver, and said second transmitter;
programming in said second processor to actuate said second transmitter to relay data input through said second input device to said first receiver;
programming in said second processor to actuate said interface output device to present data received by said second receiver from said first transmitter;
programming in said first processor to:
actuate said starter to activate said engine at a time interval before a specified departure time, said specified departure time being input through one of said input device inside said vehicle and said second input device;
actuate said heater if internal temperature data from said first thermometer indicates that internal temperature is below a specified internal temperature after said starter is actuated, said specified internal temperature being input through one of said input device inside said vehicle and said second input device;
actuate said air conditioner if internal temperature data from said first thermometer indicates that internal temperature is above said specified internal temperature after said starter is actuated; and
actuate said kill switch if said first sensor does not determine that said vehicle has been put into gear within a specified time after said specified departure time.

2. The system of claim 1, further comprising:
a second thermometer outside said vehicle and being in data communication with said first processor;
a windshield temperature sensor in data communication with said first processor;
a humidity sensor in data communication with said first processor; and
programming in said first processor to:
determine said time interval before said specified departure time based on said specified internal temperature, data from said first thermometer, data from said second thermometer, data from said windshield temperature sensor, and data from said humidity sensor; and
actuate said defroster if data from at least one of said first thermometer, second thermometer, windshield temperature sensor, and humidity sensor indicates that ice or snow is likely to be on said windshield after said starter is actuated.

3. The system of claim 2, further comprising at least one of:
programming in said first processor to actuate said first transmitter to send reminder data to said second receiver for presentation by said interface output device to remind a user of said specified departure time; and
programming in said second processor to actuate said interface output device to remind a user of said specified departure time.

4. The system of claim 2, wherein said specified time after said specified departure time is input through one of said input device inside said vehicle and said second input device.

5. The system of claim 1, further comprising:
a second thermometer outside said vehicle and being in data communication with said first processor;
a windshield temperature sensor in data communication with said first processor;
a humidity sensor in data communication with said first processor; and
programming in said first processor to actuate said defroster if data from at least one of said first thermometer, said second thermometer, said windshield temperature sensor, and said humidity sensor indicates that ice or snow is likely to be on said windshield after said starter is actuated.

6. The system of claim 5, wherein:
said time interval before said specified departure time is input through one of said input device inside said vehicle and said second input device; and
said specified time after said specified departure time is input through one of said input device inside said vehicle and said second input device.

7. The system of claim 5, further comprising at least one of:
programming in said first processor to actuate said first transmitter to send reminder data to said second receiver for presentation by said interface output device to remind a user of said specified departure time; and
programming in said second processor to actuate said interface output device to remind a user of said specified departure time.

8. The system of claim 1, wherein:
a weather condition is input to said first processor through one of said input device inside said vehicle and said second input device; and
said first processor includes programming to actuate said defroster after said starter is actuated if said input weather condition indicates that ice or snow is likely to be on said windshield.

9. The system of claim 8, wherein said time interval before said specified departure time is based on said input weather condition.

10. The system of claim 8, wherein said time interval before said specified departure time is input through one of said input device inside said vehicle and said second input device.

11. A climate control system for a vehicle, comprising a vehicle unit and a remote unit, wherein:
said vehicle unit is coupled to said vehicle and comprises:
a first input device;
a first interface output device;
a first thermometer inside said vehicle;
a first sensor to determine if said vehicle has been put into gear;
a clock;
a receiver; and
a first processor in data communication with said first input device, said first interface output device, said first thermometer, said first sensor, said clock, said receiver, a heater of said vehicle, an air conditioner of said vehicle, a starter of said vehicle for activating an engine of said vehicle, and an engine-off mechanism of said vehicle;
said remote unit comprises:
a second input device;
a transmitter for communicating with said vehicle unit receiver;
a second processor in data communication with said second input device and said transmitter; and
programming in said second processor to actuate said transmitter to relay data input through said second input device to said first receiver; and
said first processor includes programming to:
actuate said starter to activate said engine at a time interval before a specified departure time, said specified departure time being input through one of said first input device and said second input device;
actuate said heater if internal temperature data from said first thermometer indicates that internal temperature is below a specified internal temperature after said starter is actuated, said specified internal temperature being input through one of said first input device and said second input device;
actuate said air conditioner if internal temperature data from said first thermometer indicates that internal temperature is above said specified internal temperature after said starter is actuated; and
actuate said engine-off mechanism if said first sensor does not determine that said vehicle has been put into gear within a specified time after said specified departure time; and
said specified time after said specified departure time is a standard preselected time interval or is input through one of said first input device and said second input device.

12. The system of claim 11, wherein said vehicle unit further comprises:
a second thermometer outside said vehicle and being in data communication with said first processor;
a windshield temperature sensor in data communication with said first processor;
a humidity sensor in data communication with said first processor; and
programming in said first processor to actuate said defroster if data from at least one of said first thermometer, said second thermometer, said windshield temperature sensor, and said humidity sensor indicates that ice or snow is likely to be on a windshield of said vehicle after said starter is actuated.

13. The system of claim 12, further comprising programming in said first processor to determine said time interval before said specified departure time based on said specified internal temperature, data from said first thermometer, data from said second thermometer, data from said windshield temperature sensor, and data from said humidity sensor.

14. The system of claim 12, wherein said time interval before said specified departure time is input through one of said first input device and said second input device.

15. The system of claim 12, wherein said remote unit includes a second interface output device in data communication with said second processor, and wherein at least one of:
(A) said vehicle unit includes a transmitter; said remote unit includes a receiver for communicating with said vehicle unit transmitter; and said first processor includes programming to actuate said first transmitter to send reminder data to said second receiver for presentation by said second interface output device to remind a user of said specified departure time; or
(B) said second processor includes programming to actuate said second interface output device to remind a user of said specified departure time.

16. The system of claim 11, further comprising programming in said first processor to determine said time interval before said specified departure time based on said specified internal temperature and data from said first thermometer.

17. The system of claim 16, wherein said remote unit includes a second interface output device in data communication with said second processor, and wherein at least one of:
(A) said vehicle unit includes a transmitter; said remote unit includes a receiver for communicating with said vehicle unit transmitter; and said first processor includes programming to actuate said first transmitter to send reminder data to said second receiver for presentation by said second interface output device to remind a user of said specified departure time; or
(B) said second processor includes programming to actuate said second interface output device to remind a user of said specified departure time.

18. The system of claim 17, wherein:
said first processor is in data communication with a radio of said vehicle;
said first processor is in data communication with a seat temperature control device of said vehicle;
said first processor includes programming to actuate said radio to a preselected station at or before said specified departure time after said starter is actuated, said preselected station being input through one of said first input device and said second input device; and
said first processor includes programming to actuate said seat temperature control device to warm a seat of said vehicle if internal temperature data from said first thermometer indicates that internal temperature is below a specified internal temperature after said starter is actuated.

19. The system of claim 11, wherein said time interval before said specified departure time is input through one of said first input device and said second input device.

20. The system of claim 19, wherein:
said remote unit includes a second interface output device in data communication with said second processor;
said first processor is in data communication with a radio of said vehicle;
said first processor is in data communication with a seat temperature control device of said vehicle;
said first processor includes programming to actuate said radio to a preselected station at or before said specified departure time after said starter is actuated, said preselected station being input through one of said first input device and said second input device;
said first processor includes programming to actuate said seat temperature control device to warm a seat of said vehicle if internal temperature data from said first thermometer indicates that internal temperature is below a specified internal temperature after said starter is actuated; and
at least one of:
(A) said vehicle unit includes a transmitter; said remote unit includes a receiver for communicating with said vehicle unit transmitter; and said first processor includes programming to actuate said first transmitter to send reminder data to said second receiver for presentation by said second interface output device to remind a user of said specified departure time; or
(B) said second processor includes programming to actuate said second interface output device to remind a user of said specified departure time.
